(19) United States
(12) Patent Application Publication
(10) Pub. No.: US 2023/0036492 A1
(43) Pub. Date: Feb. 2, 2023

(54) HOUSING STRUCTURE OF PORTABLE ELECTRONIC DEVICE

(71) Applicant: Acer Incorporated, New Taipei City (TW)

(72) Inventor: Chi-Yuan Liu, New Taipei City (TW)

(73) Assignee: Acer Incorporated, New Taipei City (TW)

(21) Appl. No.: 17/715,051

(22) Filed: Apr. 7, 2022

(30) Foreign Application Priority Data
Jul. 28, 2021 (TW) 110127651

(51) Int. Cl. G06F 1/16

(52) U.S. Cl. CPC G06F 1/1656; G06F 1/1637

(57) ABSTRACT

Provided is a housing structure of a portable electronic device including a bezel and a back cover. The bezel has a frame body and multiple first fixing assemblies arranged along the frame body. The back cover has a cover body and multiple second fixing assemblies arranged along a peripheral edge of the cover body. The first fixing assemblies and the second fixing assemblies engage with each other along the peripheral edge for the bezel and the back cover to be locked together.

### CROSS-REFERENCE TO RELATED APPLICATION

This application claims the priority benefit of Taiwan application serial no. 110127651, filed on Jul. 28, 2021. The entirety of the above-mentioned patent application is hereby incorporated by reference herein and made a part of this specification.

### BACKGROUND

### Technical Field

The disclosure relates to a housing structure, and more particularly to a housing structure of a portable electronic device.

### Description of Related Art

Generally speaking, portable electronic devices, such as notebook computers or tablet computers, mostly employ hook structures as a customary medium for mutual integration, which means the hook structures are used for housings to maintain a state of interlocking in multiple dimensions.

However, in recent years, as portable electronic devices tend to be designed thinner and lighter with application of narrow bezels to display screens, the existing hook structures can no longer be used because it requires necessary sufficient space to dispose and arrange these hook structures for the housings to stay interlocked in multiple dimensions.

Although the above purposes can be achieved by reducing the size of these hook structures, problems such as weakening of the housings arise accordingly. Therefore, how to provide a housing structure satisfying the above requirements is actually an issue that people skilled in the art needs to consider and solve.

### SUMMARY

The disclosure provides a housing structure, where first fixing assemblies of a bezel and second fixing assemblies of a back cover engage with each other along a peripheral edge to achieve a multi-dimensional locking effect.

The housing structure of a portable electronic device of the disclosure includes a bezel and a back cover. The bezel has a frame body and multiple first fixing assemblies arranged along the frame body. The back cover has a cover body and multiple second fixing assemblies arranged along a peripheral edge of the cover body. The first fixing assemblies engage with the second fixing assemblies along the peripheral edge for the bezel and the back cover to be locked together along the peripheral edge.

Based on the above, in relevant embodiments of the disclosure, the housing structure includes a bezel and a back cover. The bezel has a frame body and multiple first fixing assemblies arranged along the frame body. The back cover has a cover body and multiple second fixing assemblies arranged along a peripheral edge of the cover body. The first fixing assemblies engage with the second fixing assemblies along the peripheral edge for the bezel and the back cover to be locked together along the peripheral edge.

In this way, these first fixing assemblies and these second fixing assemblies engage with each other along the peripheral edge. The peripheral edge is equivalent to providing at least two-dimensional locking and limiting effects, and the fixing assemblies engaging with each other provide at least one-dimensional locking and limiting effects. Therefore, the fixing assemblies of the disclosure may achieve multi-dimensional locking and limiting effects in a limited volume, thereby effectively reducing the volume occupied by fixing assemblies in a housing structure to satisfy design requirements of portable electronic devices for being lightweight and having narrow frames.

### BRIEF DESCRIPTION OF THE DRAWINGS

FIG. 1 is a schematic view of a portable electronic device according to an embodiment of the disclosure.

FIG. 2 is an exploded view of partial components of the portable electronic device in FIG. 1.

FIG. 3 illustrates a bezel of FIG. 2 from another perspective.

FIG. 4 is a partial cross-sectional view of a housing structure of FIG. 1.

FIG. 5 is a partial cross-sectional view of the housing structure of FIG. 1 from another perspective.

### DESCRIPTION OF THE EMBODIMENTS

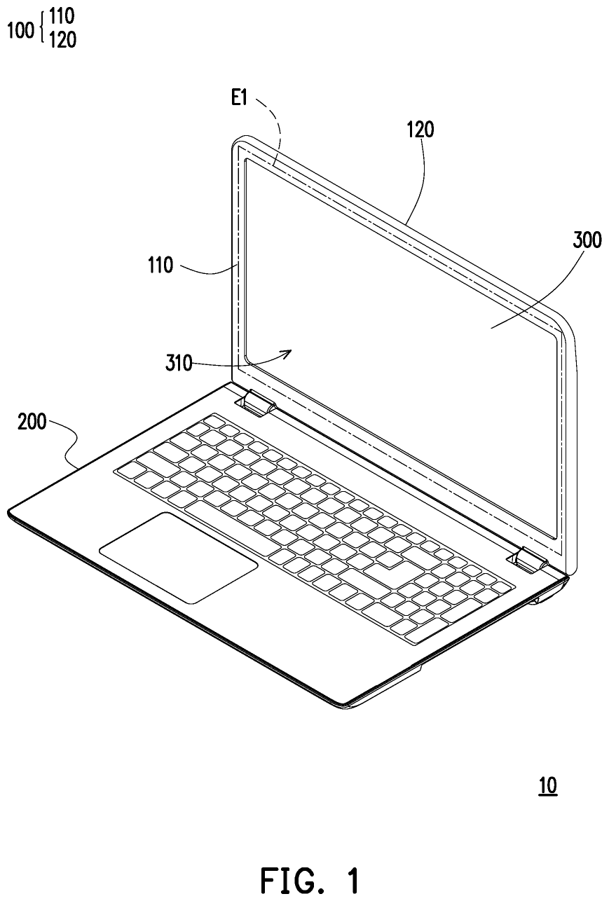

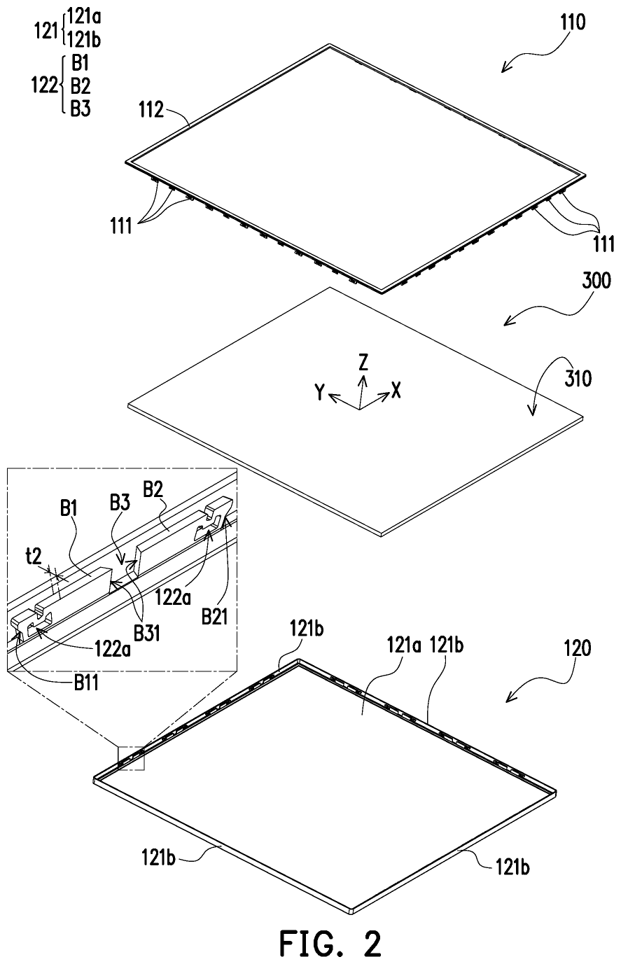

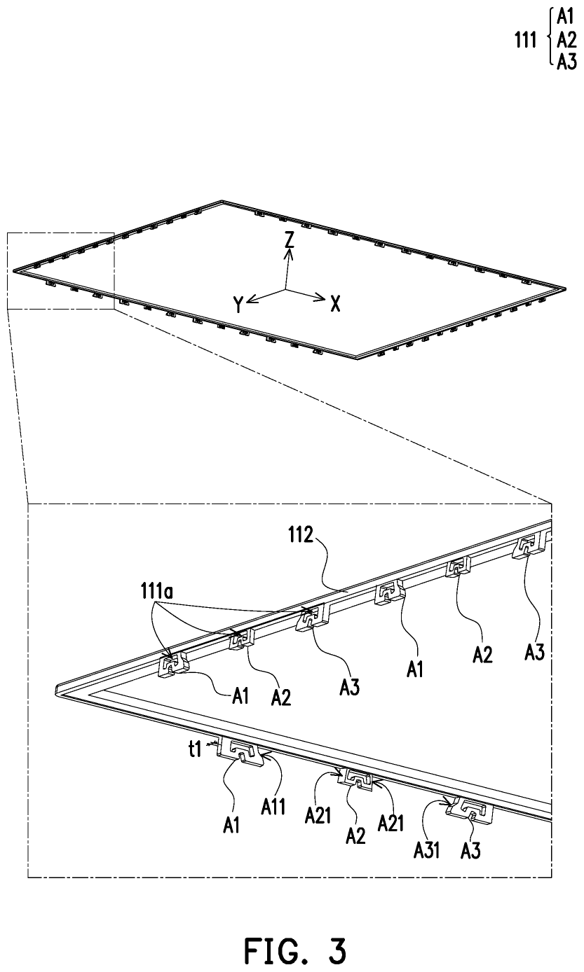

FIG. 1 is a schematic view of a portable electronic device according to an embodiment of the disclosure. FIG. 2 is an exploded view of partial components of the portable electronic device in FIG. 1. FIG. 3 illustrates a bezel of FIG. 2 from another perspective. With reference to FIG. 1 to FIG. 3 together, in this embodiment, a portable electronic device 10 is, for example, a notebook computer, including a host 200, a housing structure 100, and a display module 300. The housing structure 100 is pivotally connected to the host 200, and the housing structure 100 includes a bezel 110 and a back cover 120. The bezel 110 has a frame body 112 and multiple first fixing assemblies 111 (partially shown in FIG. 2 as examples), and the first fixing assemblies 111 are arranged along the frame body 112. The back cover 120 has a cover body 121 and multiple second fixing assemblies 122, and the second fixing assemblies 122 are arranged along a peripheral edge E1 of the cover body 121. The first fixing assemblies 111 engage with the second fixing assemblies 122 along the peripheral edge E1 for the bezel 110 and the back cover 120 to be locked together along the peripheral edge E1. In another embodiment not illustrated, the portable electronic device may also be a tablet computer.

It should be noted that the peripheral edge E1 of the cover body 121 is equivalent to an overlapping part of the bezel 110 and the back cover 120, and is also equivalent to a circular path of the bezel 110 surrounding a display surface 310 of a display module 300 (shown as a rectangular path in this embodiment) as shown in FIG. 1. A rectangular coordinate system X-Y-Z is also provided here for the display surface 310 to be substantially located on or parallel to an X-Y plane for reference of subsequent description.

Based on the above, with comparison of FIG. 1 and FIG. 2, the first fixing assemblies 111 and the second fixing assemblies 122, after engaging with each other along the peripheral edge E1, not only provide a locking effect along a Z axis but also at least provide locking and limiting effects on the X-Y plane by being along the peripheral edge E1 surrounding the display surface 310. Therefore, the required locking effect in multiple dimensions provided to the bezel 110 and the back cover 120 is completed.

Next, with reference to FIG. 2 and FIG. 3, in this embodiment, each of the first fixing assemblies 111 is formed by a component A1, a component A2, and a component A3 arranged along the frame body 112, where the component A2 is located between the component A1 and the component A3 with spacings. In other words, the first fixing assemblies 111 are formed by circularly arranging the components A1, the components A2, and the components A3 along the peripheral edge E1. Correspondingly, each of the second fixing assemblies 122 is formed by a component B1 and a component B2 arranged along the peripheral edge E1 with spacings. In other words, the second fixing assemblies 122 are formed by circularly arranging the components B1 and the components B2 along the peripheral edge E1.

Furthermore, as shown in FIG. 3, the component A1 and the component A3 of the first fixing assembly 111 are ladder-shaped pieces (or wedge pieces) opposite to each other, and the component A2 substantially serves as a center of symmetry of the component A1 and the component A3. Here, the component A1 has a first wedge surface A11, the component A3 has a first wedge surface A31, and the first wedge surface A11 and the first wedge surface A31 are opposite to each other with the component A2 interposed therebetween. The component A2 has two first wedge surfaces A21 facing away from each other, with one of the first wedge surfaces A21 facing the first wedge surface A11 and the other of the first wedge surfaces A21 facing the first wedge surface A31.

Correspondingly, as shown in a partial enlarged view in FIG. 2, the component B1 and the component B2 are ladder-shaped pieces (or wedge pieces) facing away from each other, and a recess B3 is formed therebetween. The component B1 has a second wedge surface B11, and the component B2 has a second wedge surface B21, which faces away from the second wedge surface B11. On two opposite sides of the recess B3 are two second wedge surfaces B31, one of which is substantially a backside of the component B1 facing away from the second wedge surface B11 and the other of which is substantially a backside of the component B2 facing away from the second wedge surface B21.

In addition, the cover body 121 of the back cover 120 includes a bottom plate 121a and multiple sidewalls 121b extending from the bottom plate 121a (shown as four sidewalls 121b in this embodiment). The bottom plate 121a is located on (or parallel to) the X-Y plane. These sidewalls 121b are adjacently connected with each other to form the peripheral edge E1. The second fixing assemblies 122 stand on the bottom plate 121a and are adjacently attached to the sidewalls 121b, respectively.

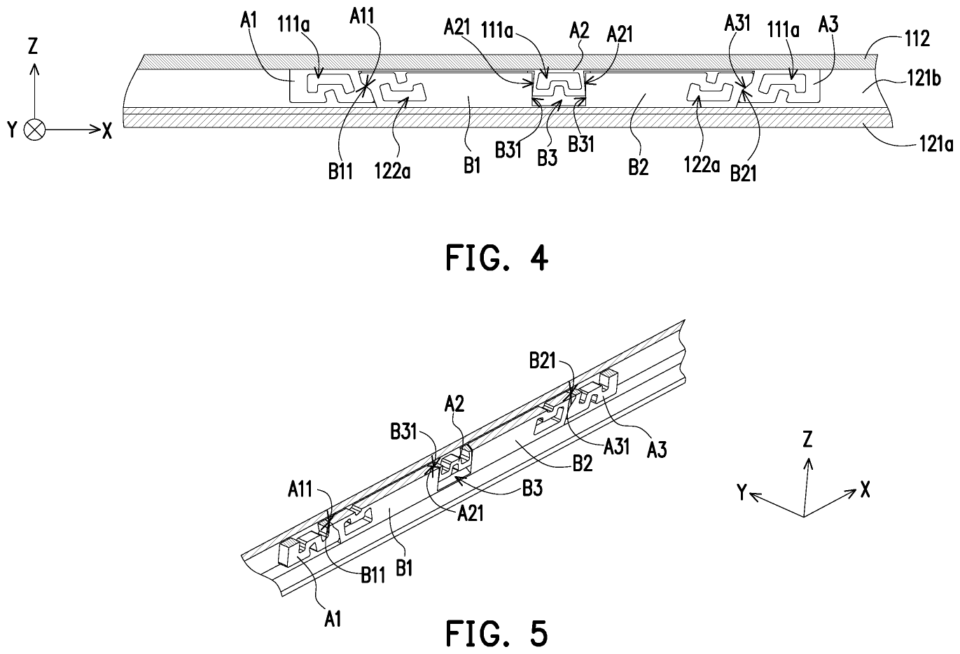

FIG. 4 is a partial cross-sectional view of a housing structure of FIG. 1. With reference to FIG. 2 to FIG. 4 together, in this embodiment, when the bezel 110 and the back cover 120 are assembled together for accommodating the display module 300, the display surface 310 is exposed from the bezel 110, and the first fixing assemblies 111 and the second fixing assemblies 122 alternately and complementarily engage with each other. Furthermore, the components B1 and B2 of the second fixing assemblies 122 are fitted between the components A1 to A3 of the first fixing assemblies 111, and the component A2 is embedded between the components B1 and B2.

Here, a disassembly axial direction (along the Z axis) of the first fixing assemblies 111 and the second fixing assemblies 122 is orthogonal to the bottom plate 121a and is parallel to the sidewalls 121b, and the fitted first fixing assemblies 111 substantially abut against the sidewalls 121b. Furthermore, as shown in FIG. 4, the first wedge surfaces A11, A21, A31 and the second wedge surfaces B11, B21, B31 are inclined with respect to the bottom plate 121a, and the first wedge surfaces A11, A21, A31 and the second wedge surfaces B11, B21, B31 abut against each other correspondingly (the relationship of abutting correspondingly is shown in FIG. 4 and is not described here). In other words, the first wedge surfaces A11, A21, A31 and the second wedge surfaces B11, B21, B31 are inclined with respect to the disassembly axial direction (the Z axis) of the first fixing assemblies 111 and the second fixing assemblies 122, and abut against each other correspondingly. In this way, these wedge surfaces may provide a locking effect like hooks to facilitate locking and limiting of the bezel 110 and the back cover 120 along the Z axis.

It should be mentioned that, as shown in FIG. 4, the first fixing assemblies 111 and the second fixing assemblies 122 of this embodiment have hollow parts 111a and 122a for elasticity along the peripheral edge E1, which helps the first fixing assemblies 111 and the second fixing assemblies 122 produce corresponding elastic deformation when the first fixing assemblies 111 and the second fixing assemblies 122 are disassembled along the Z axis, thereby providing a labor-saving effect.

More importantly, as mentioned above, the first fixing assemblies 111 and the second fixing assemblies 122 are arranged around the display surface 310 along the peripheral edge E1. Therefore, in addition to the locking and limiting effects of the Z axis, locking and limiting effects on the X-Y plane may also be produced.

FIG. 5 is a partial cross-sectional view of the housing structure of FIG. 1 from another perspective. With reference to FIG. 5, in this embodiment, among the first wedge surfaces A11, A21, A31 and the second wedge surfaces B11, B21, and B31 abutting against each other correspondingly, the first wedge surface A11, the second wedge surface B31, and the second wedge surface B21 are further inclined with respect to the sidewalls 121b and face the sidewalls 121b. The first wedge surface A21, the first wedge surface A31, and the second wedge surface B11 are further inclined with respect to the sidewalls 121b and face away from the sidewalls 121b. In this way, the inclined state of the above wedge surfaces may further enable the first fixing assemblies 111 and the second fixing assemblies 122 to produce a limiting effect along a Y axis. At the same time, the sidewalls 121b are used to provide a blocking effect (along the Y axis), which may further improve stability and structural strength of components after combination. To put it simply, each of these wedge surfaces of the first fixing assemblies 111 and the second fixing assemblies 122 has the locking and limiting effects of both the Z axis and the Y axis.

It should also be mentioned that, with reference to FIG. 2 and FIG. 3, in this embodiment, a thickness t1 of the components A1 to A3 of the first fixing assembly 111 along the peripheral edge E1 is equivalent to a thickness t2 of the components B1 and B2 of the second fixing assembly 122 along the peripheral edge E1, which means the fixing structure of this embodiment may be disposed and arranged along the peripheral edge E1 with an equal thickness, thereby effectively reducing its volume. The first fixing assemblies 111 and the second fixing assemblies 122 may be designed with the equal thickness because of the configuration features shown in FIG. 2 to FIG. 5 above.

In summary, in the above embodiments of the disclosure, the housing structure includes a bezel and a back cover. The bezel has a frame body and multiple first fixing assemblies arranged along the frame body. The back cover has a cover body and multiple second fixing assemblies arranged along a peripheral edge of the cover body. The first fixing assemblies engage with the second fixing assemblies along the peripheral edge for the bezel and the back cover to be locked together along the peripheral edge.

In this way, the first fixing assemblies and the second fixing assemblies engage with each other along the peripheral edge. The peripheral edge is equivalent to providing at least two-dimensional locking and limiting effects, and the fixing assemblies engaging with each other provide at least one-dimensional locking and limiting effects. Therefore, the fixing assemblies of the disclosure may achieve the multi-dimensional locking and limiting effects in a limited volume, thereby effectively reducing the volume occupied by fixing assemblies in a housing structure to satisfy design requirements of portable electronic devices for being lightweight and having narrow frames.

What is claimed is:

1. A housing structure of a portable electronic device, comprising:
a bezel, having a frame body and a plurality of first fixing assemblies arranged along the frame body; and
a back cover, having a cover body and a plurality of second fixing assemblies arranged along a peripheral edge of the cover body, wherein the plurality of first fixing assemblies engage with the plurality of second fixing assemblies along the peripheral edge for the bezel and the back cover to be locked together along the peripheral edge.

2. The housing structure of the portable electronic device according to claim 1, wherein the plurality of first fixing assemblies and the plurality of second fixing assemblies have a same thickness along the peripheral edge.

3. The housing structure of the portable electronic device according to claim 1, wherein the cover body comprises a bottom plate and a plurality of sidewalls extending from the bottom plate, the plurality of sidewalls are adjacently connected with each other to form the peripheral edge, and the plurality of second fixing assemblies stand on the bottom plate and are respectively adjacently attached to the plurality of sidewalls.

4. The housing structure of the portable electronic device according to claim 3, wherein the plurality of first fixing assemblies and the plurality of second fixing assemblies alternately and complementarily engage with each other, and the plurality of first fixing assemblies abut against the plurality of sidewalls.

5. The housing structure of the portable electronic device according to claim 3, wherein a disassembly axial direction of the plurality of first fixing assemblies and the plurality of second fixing assemblies is orthogonal to the bottom plate and is parallel to the plurality of sidewalls.

6. The housing structure of the portable electronic device according to claim 3, wherein the plurality of first fixing assemblies have a plurality of first wedge surfaces, the plurality of second fixing assemblies have a plurality of second wedge surfaces, the plurality of first wedge surfaces and the plurality of second wedge surfaces are inclined with respect to the sidewalls and face the sidewalls, and the plurality of first wedge surfaces and the plurality of second wedge surfaces abut against each other correspondingly.

7. The housing structure of the portable electronic device according to claim 3, wherein the plurality of first fixing assemblies have a plurality of first wedge surfaces, the plurality of second fixing assemblies have a plurality of second wedge surfaces, the plurality of first wedge surfaces and the plurality of second wedge surfaces are inclined with respect to the bottom plate and face the bottom plate, and the plurality of first wedge surfaces and the plurality of second wedge surfaces abut against each other correspondingly.

8. The housing structure of the portable electronic device according to claim 3, wherein the portable electronic device has a display module, accommodated between the bezel and the back cover, a display surface of the display module is exposed from the bezel, and the display surface is parallel to the bottom plate.

9. The housing structure of the portable electronic device according to claim 1, wherein the plurality of first fixing assemblies have a plurality of first wedge surfaces, the plurality of second fixing assemblies have a plurality of second wedge surfaces, and the plurality of first wedge surfaces and the plurality of second wedge surfaces are inclined with respect to a disassembly axial direction of the plurality of first fixing assemblies and the plurality of second fixing assemblies and abut against each other correspondingly.

10. The housing structure of the portable electronic device according to claim 1, wherein the plurality of first fixing assemblies and the plurality of second fixing assemblies have a hollow part for elasticity along the peripheral edge.

11. The housing structure of the portable electronic device according to claim 1, wherein each of the plurality of first fixing assemblies is formed by a component (A1), a component (A2), and a component (A3) arranged along the frame body, and the component (A2) is located between the component (A1) and the component (A3) with spacings.

12. The housing structure of the portable electronic device according to claim 11, wherein the component (A1) and the component (A3) are symmetrical with the component (A2).

13. The housing structure of the portable electronic device according to claim 11, wherein each of the plurality of second fixing assemblies is formed by a component (B1) and a component (B2) arranged along the peripheral edge with spacings, and the component (B1) and the component (B2) are embedded between the component (A1), the component (A2), and the component (A3) of one of the plurality of first fastening assemblies.

14. The housing structure of the portable electronic device according to claim 1, wherein each of the plurality of second fixing assemblies is formed by a component (B1) and a component (B2) arranged along the peripheral edge, a recess is formed between the component (B1) and the component (B2), and a component of one of the plurality of first fixing assemblies is embedded in the recess.
